(19) United States
(12) Patent Application Publication
(10) Pub. No.: US 2006/0277107 A1
(43) Pub. Date: Dec. 7, 2006

(54) Apparatus and method for increasing retail marketing through cart sanitizing shopper inducement

(76) Inventors: Jim Beal, Scaramento, CA (US); Rodger H. Rast, Gold River, CA (US)

Correspondence Address: Rastar Corporation;Suite 310 MS 337, 11230 Gold Express Dr., Gold River, CA, 95670, US

(21) Appl. No.: 11/448,487

(22) Filed: Jun. 6, 2006

Related U.S. Application Data
(60) Provisional application No. 60/688,024, filed on Jun. 6, 2005.

(51) Int. Cl. G06Q 30/00

(52) U.S. Cl. 705/14

(57) ABSTRACT

An apparatus and method for generating cooperative marketing at a retail establishment in which sales are driven in response to a cart sanitizing inducement. By way of example, the apparatus comprises a means for sanitizing a shopping cart in preparation for patron use at a retail establishment and a means for marketing a select group of items for sale at that retail establishment. The physical area for the select group of items is provided by the retail establishment in exchange with a first system operator for providing the means for sanitizing the shopping carts. The retail establishment remits a portion of the sales driven from the marketing of the select items to the company providing the sanitizing inducement. Additional aspects of the invention provide retailer-customized multimedia narrowcast network system for generating initial and ongoing revenue through a vendor inducement at the last point-of-contact.

### CROSS-REFERENCE TO RELATED APPLICATIONS

This application claims priority from provisional patent application Ser. No. 60/688,024 filed Jun. 6, 2005, which is incorporated herein in its entirety.

### STATEMENT OF FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention pertains generally to retail marketing and more particularly to a marketing method in which sales are driven in response to a shopping cart sanitation inducement.

2. Description of the Background Art

Supermarket retailers are facing rapidly growing competition (e.g., big-box stores) and reduced market share. In addition, all retail establishments are facing another harsh reality—a recently discovered health-safety threat to customers and employees.

Currently, shopping carts are used at numerous retail establishments, such as grocery stores, drug stores, super stores, hardware stores and assorted other retail shopping venues. The carts have been a convenient means of carrying a plurality of items to a register for purchase. Unfortunately, the handles and contact surfaces of the cart also provide a carrier for transmitting unhealthy germs from one patron to another.

Therefore, a need exists for a means for assuring that carts are sanitized. The method and system in accordance with the present invention satisfies that need, as well as others, and overcomes deficiencies in previously known techniques.

### BRIEF SUMMARY OF THE INVENTION

The present invention describes a system and method for facilitating cooperative marketing. This invention provides an integrated, preferably ‘neutral vendor’, marketing-at-retail method in which sales are driven in response to an inducement. A preferred embodiment of the invention describes a health-safety inducement, in particular a shopping cart sanitation inducement. The present kiosk-based, retailer-customized, digital-signage narrowcast network system invention generates substantial initial and ongoing operational revenue through a major product marketer (vendor) inducement—that of ‘last-point-of-contact’ product exposure (promotion) through scheduled digital video ad sales. The system is designed to expand to include additional shopper inducements in three other categories: retailer-distinctive shopping, product education, and shopping economy.

Descriptions are provided herein for a large number of aspects, modes, embodiments, variations and features of the invention. It should be readily understood that a given retail system may operate according to the teachings of the present system without implementing more than one of these elements. It should also be readily realized that the elements of the invention generally describe what could span numerous implementation phases and levels of sophistication, wherein utility is provided from implementations which range from the very simple to the substantially more complex. Ultimately, this kiosk-based marketing-at-retail, retailer-customized, digital-signage narrowcast network system will preferably include shopper inducements in at least four major categories: retailer-distinctive shopping, product education, shopping economy, and health-safety in addition to the essential product marketer (vendor) inducement of product exposure through scheduled digital video ad sales.

One aspect of the invention in the health-safety inducement category is directed at solving the problem of unsanitary shopping carts, and the transmission of diseases, which can result thereby. Spot testing of shopping carts and baskets have shown an alarming level of pathogens. Development and deployment of the present system is intended to overcome these sanitation issues, from which disease has been spread across all sectors of our economy.

The present system describes apparatus and method for sanitizing carts and for assuring widespread deployment of cart sanitation. One of the problems with addressing the problem has been that it would be difficult to charge consumers each time a shopping cart is procured for sanitation of the shopping cart. User's may consider this to be the responsibility of the retailer. Albeit, creating a sanitation mechanism and deploying it represent a significant cost to a retailer, the expenditure would not generally be considered revenue generating. It is difficult for the retail industry to address this problem, due to regulatory issues, development cost issues, training issues, deployment issues, ongoing cost issues, and so forth. The problem has existed for many years. It should be realized that implementing such a system requires not only development, testing, overcoming minor regulatory issues, and implementing hardware and software; but it involves training patrons as to the advantages and maintaining the systems within the retail stores.

The present invention addresses these many issues and provides a system and method for assuring that shopping carts can be properly sanitized, while not negatively impacting retail profits. The present invention allows the development and deployment issues of a cart sanitizing system to be spread across a number of retailers. Furthermore, deployment of the system can actually increase retail profitability and customer loyalty.

It should be appreciated that the term “shopping cart” is used herein to mean conventional physical shopping carts (i.e., not the iconic symbol used for collecting items from an internet browser wherein no physical contact is involved), as well as other reusable temporary purchase item repositories for use in the retail establishment such as baskets, buckets, hand trucks, wheel chair carts, and so forth. The more conventional shopping cart is a small wheeled conveyance (i.e., approximately three feet long, two feet wide, and three feet high) which typically has a latticed (web) exterior construction of plastic or steel.

One embodiment of the invention describes an apparatus for retail marketing in response to a cart sanitizing inducement, comprising: (a) means for sanitizing a shopping cart in preparation for patron use at a retail establishment; (b) wherein said sanitizing means is provided by a first system operator; (c) means for displaying a select group of items for sale at the retail establishment; (d) wherein a display area for said select group of items is provided by the retail establishment (or second company) in exchange (full or partial) with said first system operator for providing the means for sanitizing said shopping cart; and (e) means for remitting at least a portion of the sales of said select group of items in said retail establishment, to said first system operator.

The means for displaying the select group of items is configured for either physically displaying items for purchase, or presenting coupons, or presenting information about items available for purchase either in the retail establishment or from third parties. The means for displaying the select group of items may, for example, comprise a display apparatus configured for retaining a plurality of the group of items which may be physically removed from the means for displaying for purchase by the patron. The items displayed may for instance comprise various sanitizers, or new products which are not otherwise carried by the retailers. In one mode of the invention, these items may be carried by the retailer at the retail establishment for only a short-term, or alternatively, may be then carried on conventional shelf space after sufficient levels of sales are driven by the system.

The means for displaying the select group may optionally comprise a video or multimedia presentation system upon which information is provided on said select group of items. The display system can be configured to operate continuously, or more preferably in response to the presence and input from patrons. Initial and ongoing content presented on the display system is comprised of product exposure (promotion) through ad sales by product marketers. The principle revenues for the system may be generated in this manner, or a related manner. Weekly or monthly ad sale revenue is preferably divided by agreement between retail establishment and first system operator, or for other considerations. In addition, revenue sharing can arise between the manufacturer and the first system operator in response to new product introductions becoming successful, and for example moving onto retail shelves or other distribution venues. For example, small manufacturers may prefer relinquishing a percentage of on-going sales and/or equity in return for the product exposure.

The means for displaying the select group of items is preferably maintained by the first system operator, wherein the retailer need not manage these aspects of the overall retail experience. The first system operator profits from their efforts with the inventive sales system in response to the amount of additional sales that are driven through the retail establishment. This may arise in a number of different ways. For example, in one mode of the invention the first system operator receives a percentage of sales for items purchased from the display area of the retail marketing system. In one embodiment, the first system operator stocks the means for displaying from its own stock of items, wherein the percentage that the first system operator receives from sales include the wholesale cost of the items and a mark up value. Optionally, the first system operator could receive a percentage of the sales volume for other products described by audio and visual presentations, yet carried elsewhere in the retail store, or even outside of the store, such as ordered items, custom items, downloaded items, policies (i.e., insurance, extended warranties, and so forth).

One implementation of the system describes a method of extending retail marketing through a cart sanitizing inducement, comprising: (a) establishing a cart disinfecting means at a first retailer by a first system operator; (b) establishing a secondary marketing center by the first system operator at the retail establishment (retail establishment maintains a primary marketing environment); (c) wherein physical space for the secondary marketing center is provided by the retail establishment in exchange for the operation of the cart disinfecting means; (d) offering at least one item for sale at the secondary marketing center for purchase by patrons of the retail establishment; and (e) remitting a portion of the sale of the at least one item by the retail establishment to the first system operator.

The secondary marketing center preferably includes at least one video or multimedia presentation system to present products and services being marketed at said secondary marketing center. In a preferred embodiment, the first system operator maintains the secondary marketing center and the cart disinfecting means. It should be appreciated that the first system operator, although preferably a distinct business entity from the retailer, may alternatively have a corporate relationship, wherein the marketing center may comprise an additional profit center of the corporation associated with the retail establishment.

In one implementation of the invention, a paradigm is created in which the courtesy clerks serve as ambassadors to the incoming public and direct them toward using the equipment, providing examples and answering questions. The environment is shifted into a more pro-active situation to increase customer awareness, care and ultimately loyalty.

In one embodiment the means for remitting a portion of the sales comprises: (a) a retail trade computer system configured for executing purchase transactions in response to item codes, or UPC codes; and (b) programming operable on the retail trade computer for, (i) tracking purchases of goods within the select group of items, (ii) determining a remittance on the purchase of each item sold from the select group, (iii) summing the total remittances over an interval of time, (iv) executing a payment of the total remittances to the first company, or communicating the total remittances within said second company, or the retail establishment, toward a payment being generated to the first company. In more general terms the first company receives the space for use with the cart sanitizing and marketing system, and is paid based on the purchase response for items being marketed by that system.

In one embodiment the sanitizing means comprises a sanitizing station configured for dispensing a sanitizing agent. The sanitizing agent may be applied in a spray or liquid form, or more preferably on a wipe containing a sanitizing ingredient wherein the user wipes down the handle of the cart, or other collection mechanism for carrying prospective purchases. The wipe in this case is adapted with sufficient disinfectant to substantially reduce, preferably by killing over at least 99%, of the biological hazard posed by microorganisms on an unsanitized cart handle, or portion of the cart. In an alternate embodiment, the sanitizing means comprises a sanitizing station configured for continuous sanitizing of carts using mechanisms selected from the group of sanitizing elements consisting essentially of chemical, detergents, electromagnetic radiation, ultraviolet, infrared, heat, ultrasonic, and acoustic.

It should be appreciated that the summary describes numerous embodiments, modes, and features which may be implemented separately or in various combination without departing from the teachings of the present invention.

### BRIEF DESCRIPTION OF THE DRAWINGS

The invention will be more fully understood by reference to the following drawings which are for illustrative purposes only:

FIG. 1 is a block diagram of the retail marketing apparatus that operates in response to a cart sanitizing inducement according to an embodiment of the present invention.

FIG. 2 is a flowchart of a retail marketing method operating in response to a cart sanitizing inducement according to an embodiment of the present invention.

### DETAILED DESCRIPTION OF EMBODIMENT(S)

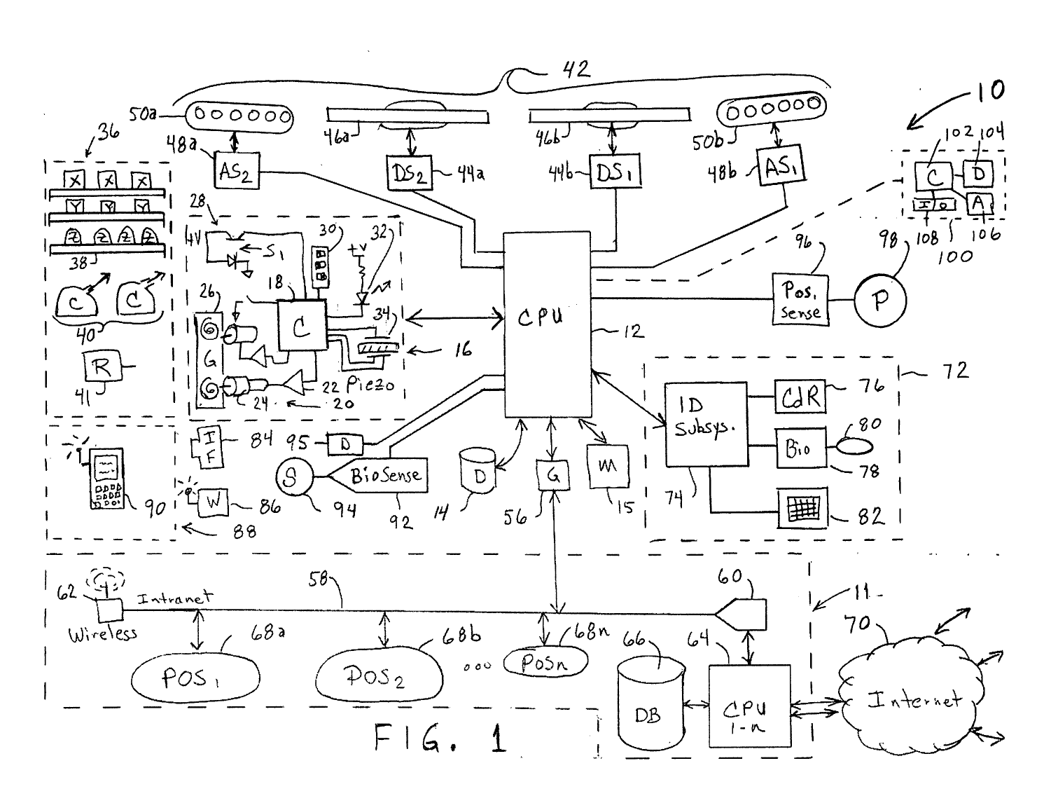

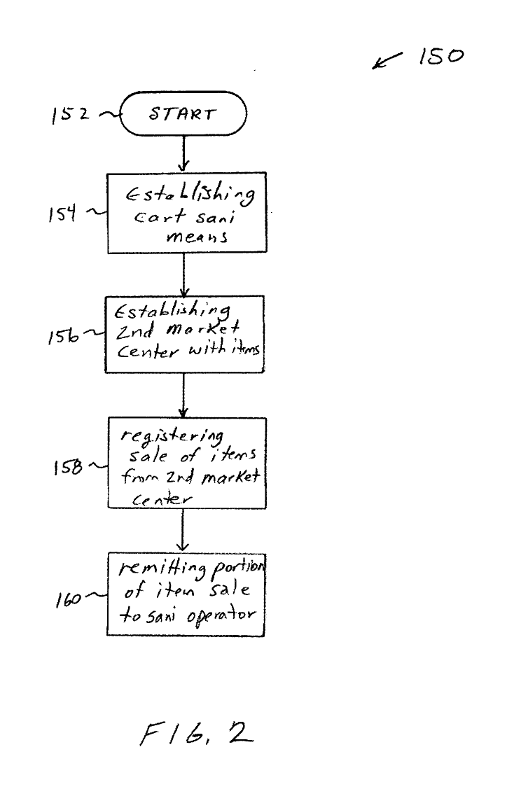

Referring more specifically to the drawings for illustrative purposes, the present invention is embodied in the method generally described in FIG. 1 and FIG. 2. The following description is presented to enable one of ordinary skill in the art to make and use the invention as provided in the context of a particular application and its requirements. Unnecessary technical details, which extend beyond the necessary information allowing a person of ordinary skill in the art to practice the invention, are preferably absent for the sake of clarity and brevity. Furthermore, it is to be understood that inventive aspects may be practiced in numerous alternative ways by one or ordinary skill without departing from the teachings of the invention. Therefore, various modifications to the preferred embodiments will be readily apparent to those skilled in the art, and the principles defined herein may be applied to other embodiments. Thus, the present invention is not intended to be limited to the embodiments shown, but is to be accorded the widest scope consistent with the principles and novel features disclosed herein.

### 1.0 INTRODUCING GENERAL ASPECTS OF THE INVENTION

The present system provides a number of benefits for retailers and patrons of retailers. The system may be deployed by retailers, or a third party. One aspect of the system involves providing sanitation of carts in combination with merchandising. As has been mentioned the pathogens being spread from unsanitary carts is a problem for patrons, as well as retailers, whose patrons AND employees are subject to infection.

The system can be utilized in any establishment in which patrons collect items in a reusable rolling cart, basket, or similar receptacle or conveyance to which the patron comes into physical contact. For example, the establishment may comprise a retail establishment, warehouse buying club, or similar selected from the group of retail trades consisting essentially of: grocery stores, drug stores, super stores, boutiques, mall stores, hardware stores, stationary stores, closeout stores, chain stores and independent retail stores.

A partial list of the features of the invention are given, these features may be optional, or used for certain embodiments, or modes, or applications of the invention. These features need not be incorporated in each embodiment of the present invention.

Full-motion multimedia-video. System can advertise services and products using a video display system, preferably including audio output. By way of example, and not limitation, this can be a main kiosk system which houses the portions of the system, such as including the wipe dispensing.

Remote Kiosks. Advertising can be directed from the system to remote devices located throughout the retail establishment. For example, a multimedia system located in the deli section, meat counter, produce section, natural foods section, take-out section, pharmacy, post office, and so forth, allows consumers to get product information even when they are not at the entrance to the store. If the cart, or patron, has been identified by the system, or another system from which information is available, then the multimedia presented can reflect their earlier interaction with the presentations. For example, the presentation can continue with other items, or display items that they showed some interest in.

Internet selectivity and programming. The system multimedia to be displayed can be downloaded over the Internet. System can also be configured with a storage area to allow at least two sets of multimedia to be downloaded, coupled to a means of service party selection of which multimedia to display, wherein after physical content on the system is changed, the service person can then select the proper matching multimedia.

Limited Data Exchange interface with retailer. An interface between the system and that of the retailer allows data to be automatically exchanged regarding updated inventory, UPC codes, pricing, items being marketed, limited control and data exchange.

Front-End Management Subsystem. Information can be sent to at least one corporate office automatically. This front-end management subsystem may generate information in the form of an instrument panel, reports, ticklers, status fields, and other convenient forms of display and/or interaction.

Automated sanitized wipe dispensing. Preferably, sanitized wipes are dispensed automatically, without the need of manual user-extraction from a container.

Non-contact Wipe Dispensing. An embodiment can be adapted with sensors for detecting a user request for a sanitizing wipe. For example, a light beam is interrupted by the body, such as hand, of the user to make a desired selection.

Multiple wipe feeder. In one embodiment the system is adapted to dispense wipes to multiple queues of patrons to speed up the sanitization process and to provide redundancy should one portion of the system become inoperable or run out of supplies.

Multiplicity Dispensing Limitation. System prevents a given user from taking an excessive number of sanitizing wipes.

Low/Out-of/Error Supplies Communication. Annunciation of when supplies fall below selected limits. By way of example, an optical indicator and/or audio annunciator, can be triggered at the physical location, with a corresponding electronic annunciation communicated by the system to one or more remote locations, such as over a wired or wireless network. Additionally, error conditions as well as status are preferably communicated to local personnel as well as remote locations.

Selective Dispensing characteristics. In one embodiment, the system can be configured with user inputs for selecting the type of sanitizer to be used, such as the scent or other aspects. In one mode different sanitizing liquids are dispensed, or different liquids are added to the sanitizer, such as according to a selected fragrance.

Direct-Audio Presentations. Directed-audio beams streaming audio to different consumers interested in different products. In this way more than one multimedia presentation can be played without the audio component of those presentations interfering with one another or disrupting other shoppers.

Presentation Including Smells. In one embodiment, the system is adapted with a repository of smells and a dispensing device which is actuated in response to consumer input, or automatically. By way of example, the smells are dispensed as a liquid which is atomized by the machine, such as using microdispensing nozzles. The machine also preferably includes means for localizing smells to the location of a specific patron.

Facial Recognition. Limiting the output of promotional consideration (e.g., coupons, discounts, samples, and so forth, or otherwise accrued) to customers in response to their presence at an associated presentation, or otherwise qualified by current or historical presence as determined by detection hardware, for example in response to facial recognition.

Automated Product Survey Collection. In one aspect of the invention, information is collected as to user responses to the presentation for a given product.

Automated Product Endorsement Collection. In one mode of the system, information is collected from patrons that have used a given product to aid other consumers.

Electronic-Enabled Carts or Carts having Identifier. In one embodiment the electronics can receive a wireless communication of a coupon, certificate, bonus, or other incentive for use when the user reaches the register, or in certain stores performing a self-service check-out procedure.

Incenting Patron to Watch Presentation. In one mode of operation patrons are provided with an incentive to continue watching one or more presentations. In one embodiment, the incentive comprises a coupon (e.g., paper or electronic) which is redeemable for a discount and/or item at the register.

Crowd Responsive Presentations. In one embodiment of the invention, the system is configured to alter the presentation in response to patron presence, response, and/or feedback.

Augmented Virtual In-Store Catalog Shopping. Extending items that can be purchased at the store with an in-store catalog shopping experience tied in with the cart system.

Holographic projections. In this optional interface, the video presentations are generated using holographic projection for one or more of the elements to provide a true three dimensional experience.

Bacteria Resistant Carts Handles. The cart handles are preferably manufactured from a bacteria resistant material to reduce the activity of pathogens and simplify the sanitizing operation.

User Handle Promotion. An anti-bacterial adhesive backed material is provided to the user for placing on the cart handle. These protect the patron while killing underlying germs. The material preferably contains printed advertising on exterior surfaces to defray at least a portion of the cost. These can be peeled off the store periodically as the layers build up, or less preferably by patrons as desired.

Multi-use User Handle. Multi-use handles or handle covers are supplied to interested patrons, such as within a promotion. These can protect the patron from pathogens with each visit. Each is preferably festooned with an advertising message.

Shopping Cart with Separable Sterilized Handle. The shopping cart is configured with a readily removable handle. In order to utilize the cart conventionally, through a handle element, the patron must receive a sterilized handle and attach it to the cart.

Cart Condition Monitoring. A means for displaying the condition of the cart in relation to a germ “detector” built into the system, such as the kiosk. This detector is configured to detect pathogens and generate an annunciation in response thereto.

Cart Filling Monitoring. Items collected into the cart/basket are registered to assure the same items are brought to the register.

Store Maintained “Convenience levels”. An honor system enforced to provide enhanced “convenience levels” to those deserving of them.

DeTagging station. Allows customers to assure that any RFID or other active tagging devices have been “terminated”.

It should be appreciated that a number of above features are particularly well suited for ongoing (later-stage) implementation, such as when earlier phases of deployment have been solidified. The paradigm of this marketing system and its wide deployment across non-specific retailer landscape provide incentives for introducing above aspects and other aspects as would benefit the retailer and/or customer. The following now describes in detail a number of aspects of the system.

1.1 Sanitizinq Methods.

There are a number primary types of hand-and-surface antimicrobial sanitizer-disinfectant technologies on the market today: (1) chlorine-based disinfectants, (2) alcohol-based antimicrobial sanitizers, (3) PCMX-based sanitizer-disinfectants [Para Chloro Meta Xylenol a.k.a. Chloroxylenol] (4) Triclosan/Triclocarbani-based antimicrobial antiseptics and sanitizers, (5) natural herbal-based sanitizers, (6) natural ozone-based sanitizers, and (7) BAC-based (Benzalkonium chloride) sanitizer-disinfectants (Benzalkonium chloride is used widely in consumer and medical applications because of its germicidal effectiveness).

However, it should be appreciated that a number of these sanitizing products do not provide broad-spectrum germicidal properties, and long-lasting (persistent) protective retentive-kill properties with a single application. The disinfectant utilized for this system preferably overcomes these shortcomings, and thus provides broad and reliable protection.

1.2 Retail Industry Players.

One primary placement target for the present system is within grocery stores. Grocery stores rank among the largest industries in America, providing about 3 million wage and salary jobs. There are about 180,000 grocery stores operating throughout the nation. With the exception of the large supermarket chains, most grocery stores are small; over 60 percent employ fewer than 10 workers. The nation's large supermarket chains sell most of the groceries to the consuming public. Out of the total industry sales of $461.1 billion, a mere 20 companies with slightly less than 16,000 stores cornered $326.7 billion of the sales or 71 percent of total sales.

Grocery retailers are under intense pressure from so called ‘Big-Box’ retailers and other discounters to survive in an increasingly competitive environment. They are seeking a stronger strategy to provide increased service and efficiency; including more automation, more prepared foods, and directing efforts to sustain staff and customer loyalties. They are seeking new and innovative ways to stand out in their customer's mind—influencing their shopping habits and growing their interest and loyalty. (Source: http://www. usatoday.com/money/industries/food/2003-10-27-grocery_x.htm; posted on Oct. 27, 2003)

Regarding food safety and the health of employees and customers, the growing shopping cart contamination problem (outlined in a prior section) is yet to be fully solved in an innovative and cost-effective way. It should be appreciated that this problem is gaining the increasing attention of the mass-broadcasting media—hence, an increased exposure to the mass grocery-shopping public.

Therefore, a tremendous opportunity currently exists to provide products and services that will enable the grocery retailing industry, to gain competitive advantages, reduce business risk, reduce employee sick day costs, increase health and hygiene of employees and customers, increase attention and interest of customers, influence shopper buying habits, increase employee and customer loyalties—so as to increase the bottom line in today's increasingly competitive environment.

Numerous other retail industries are also particularly well-suited for adopting the present system, including hardware stores, stationary/office-supply stores, department stores, nursery supply stores, clothing stores, and others.

1.3 Nexus between Pathogen Problem and Advertising.

The developers of the present system have recognized that the problem of unsanitary carts, a problem which has existed for a long period of time, can be economically solved by coupling aspects of the cart sanitization business model with forms of sales and advertising. It should be appreciated that sanitizing liquids, of some utility although not sharing the benefits of the solutions utilized herein, have been available for a period of time, as has been the ability to advertise, while nothing has been provided on the market which illustrates recognition of this cooperative connection, or nexus.

The system couples a sanitizing capability (preferably automatic, or semi-automatic), with a multimedia presentation as well as preferably having at least a portion of the products available at that location for direct sale to the consumer. The system is adapted for communicating product information endorsements and the like with the consumer.

1.4 Competitive Landscape.

Currently, there is no competition within any of the retail industries for a system as described herein. The system provides numerous methods of executing business processes to increase market share, as well as novel system hardware that provides benefits not currently achievable in the market place.

The product advertising at the point of decision which is provided by the system is preferably implemented using large-screen flat-panel display systems, which may be configured for sound output, user inputs, and a number of options described elsewhere. In one embodiment the system is “kiosk-based”, although the computer hardware can reside anywhere nearby without departing from the teachings of the present invention.

1.5 Marketing Through the Point of Need.

The type of marketing provided is specifically designed to capture attention and provide key buying information, at the point of consumer need. The system is targeted to provide substantial benefits to retailers, their vendors, and their customers. The capability of the system to test product acceptance at low cost, and to drive sales for its own products and other products, is a significant benefit. Products can be moved through the system with relative ease and low overhead, wherein newer products can reach the consumer earlier, wherein both higher revenues are achievable while patron interest levels are kept high. The system provides specific value to both product vendors and retailers by: (1) increasing vendor-product branding, (2) increasing customer base, (3) increasing customer loyalty, and (4) increasing word-of-mouth advertising.

The aspect of tying the system in with the retailer in a cooperative arrangement overcomes a number of difficulties otherwise arising with such a system. According to one mode, in which the retailer provides a small amount of high traffic retail space and a retail transaction environment as consideration for the shopping cart sanitization operation, which represents a retail service execution means, all parties benefit—except the competition. In addition, the system can provide a number of services to the retailer which would not be achievable by the retailer within the constraints of the information technology budget. The system can be deployed across numerous retail segments wherein the development costs are amortized across a wide market segment.

According to the embodiment which provides free hand and cart sanitizing for shoppers, such as retailers (e.g., grocers, and so forth), the system provides far-reaching benefits. In one embodiment, the system provides pre-treated sanitizing wipes with a safe, persistent, and skin-friendly protection while providing high levels of germ-killing power. These wipes are provided free of charge to shoppers entering the store, and initially the importance of sanitizing can be annunciated by the system, as well as usage details. Customers are provided with enhanced protection from pathogens while improving retailer image and enhancing customer loyalty. Marketing driven by the system provides additional revenue streams without increasing the management burden of the retailer. It should also be appreciated that in one preferred embodiment the retailer is free from the costs associated with purchasing the equipment or maintaining it.

1.6 Development and Use of Marketing Packets.

Direct and indirect sales are driven by the system in response to a plurality of marketing packets tailored to the given retail environment. One embodiment of the system utilizes the concept of product packets, wherein all the elements for purchase inducement and purchase execution are aggregated, so as to simplify changes to the mix over time and between stores. For example the shelves are standardized to certain sizes and are reconfigurable. Direct sales material are housed to allow rapid loading at the point of sale, and are configured with all necessary physical materials in one location. Indirect sale items may have physical goods that are associated as well, flyers coupons and the like. The system allows for the information relating to the marketing packet to be loaded over a network into the multimedia database of the system. Identifiers on the marketing packets, such as RFID, identify the packet to the system wherein automatic downloading of the multimedia and control system components commence over the internet.

The marketing packets are created for direct and indirect sales, which may be of products selected by the system operator, retailer, or from vendors seeking to gain exposure and knowledge of their fledgling product. Representatives of the system operator may contact national and regional vendors of new products to be tested or highlighted, or of products which are already sold in the stores. In one mode of the invention each marketing packet includes a fixed time multimedia market push, such as video, which may be augmented with audio, aroma, robotics, and so forth. A packet loop for the retail location is dynamically bound and played back. The system is preferably configured for adaptive playback in which the packet content is modulated in response to activity at other stations of the system (e.g., what is playing, reaction, and so forth), time of day, sales, products in-stock, customer feedback, corporate control, and so forth. Basic multimedia can be created by the vendor, or by the system operator, preferably for a fee.

### 2.0 SYSTEM EXAMPLE EMBODIMENT

FIG. 1 illustrates by way of example a block diagram 10 for an embodiment of the present system. The existing retailer infrastructure 11 is shown coupled to system 10.

System 10 is configured with control means 12, preferably one or more computers coupled to a data storage subsystem 14 (i.e., disk drive), and memory storage 15.

System 10 may be housed in a kiosk, or embedded within a merchandising system, or otherwise coupled to the elements described herein.

2.1 Sanitizing Subsystem.

One aspect of this embodiment is the cart sanitizing subsystem 16, having processor 18 controlling sanitizing mechanism 20. In one embodiment sanitizing is performed by providing wipes containing a sanitizing liquid. For this embodiment driver electronics 22 are shown coupled to motors 24 which operate mechanism 26 which contains at least one roll of wipes and sanitizing liquid. The sanitizing liquid is preferably applied to the wipes as they are dispensed, alternately the roll of wipes may be pre-moistened with sanitizing liquid. A dispenser control means 28 is shown (i.e., having at least one input although a number of inputs can be provided for collecting user selections), which depicts the use of a non-contact form of sensor, wherein germs are not passed between patrons activating or otherwise interacting with the system.

Configuration inputs 30 are shown symbolized by a DIP-switch, although any convenient means of programming, selecting, or inputting configuration may be utilized. An output means 32 is represented with an LED, although many forms of output can be utilized without departing from the invention. The outputs are provided to indicate status to both patrons and service personnel and for facilitating interaction. Outputs by way of example may include: power status, sanitizer wipe status (i.e., near empty, empty), sanitizer liquid (i.e., near empty, empty), system operational status (i.e., operational, standby, service mode, calibration, etc.), user prompts, service prompts, error codes, and so forth. Output is also preferably augmented with a local audio source 34, allowing the system to generate status audio, and to communicate locally with service persons or patrons. In one embodiment, audio input may be registered, such as through shared piezo 34, or more preferably one or more separate microphones. Registering audio input extends the user interface allowing voice commands, as well as for assessing other situations, user commands, and the like.

It should be appreciated that the system may be less preferably practiced using other forms of sanitizing, such as using optical radiation, heat, and so forth.

2.2 Merchandising Subsystem.

An associated merchandising subsystem 36 is shown with storage means 38 for retaining physical goods, and a coupon dispenser 40 for indirect offers. It will be appreciated that dispenser 40 may be configured for dispensing electronic-based offers when the patrons or their carts can be identified by the retailer, or when the patrons want the offers transferred to their personal transaction devices (e.g., smart card, cellular phone, PDA, and so forth). A reader 41 is shown according to one embodiment for detecting the presence, or absence of physical stock (i.e., items of type x, y, or z). The reader may comprise a physical sensor, an RFID system, or other means of detecting physical elements.

2.3 Multimedia Subsystem.

Multimedia subsystem 42 provides for the presentation of information about both products that are retained on merchandising system 36, as well as in the remainder of the store, or offers which are available external to the store. At least a single display controller 44a and display screen 46a are provided, although multiple screens (44b, 46b) provide the benefit of allowing the patron to select which product info they are interested in by just viewing a different screen. In one mode of the invention, when multiple screens are operating the presentations shown on them are offset in time. Example assuming three screens (A, B, C) and twelve product presentations (1-12), Screen A could show presentation n, where n is within the set {1-12}, while screen B is showing n+4, and screen C showing n+8. In this way the patron is subject to the minimum possible delay for all presentations to go by on the screens. Additional screens may be utilized so that presentations may be seen from various places in the store, while holographic imaging can allow the patron to see the display from a very wide range of angles, such as up to 360°.

2.4 Audio Subsystem.

Audio may be provided within multimedia system 42, which may utilize a conventional audio subsystem, or more preferably a directed audio subsystem. Conventional audio has the drawback that it is difficult to separate the sound when multiple audio streams are generated, and it is difficult to isolate the sound from others which are not in the vicinity. The use of directed audio, however, can allow audio to be generated for each separate offer without disrupting other patrons. In directed audio, ultrasonics are transmitted from multiple audio transducers whose output is directed to overlap in the area within which the sound is to be heard. The audio be to heard is encoded as a common beat frequency between any pair or group of overlapping transducers. The ultrasonic sound is highly directional, and only at the overlap points can be audio be heard by humans. Directed audio is shown with audio controller 48a coupled to a first directed audio panel 50a, which may contain a plurality of audio transducers in a fixed or variable orientation. Additional audio elements may be included, such as a second directed audio system with driver 48b and transducers 50b.

2.5 Communication Subsystem.

System 10 is preferably coupled into the retailer systems 11, such as through gateway 56 to intranet 58. The interface allows data to be automatically exchanged regarding updated inventory, UPC codes, pricing, items being marketed, limited control and data exchange. For example UPC codes from items x, y, or z in merchandising system 36 are entered into the database 66 of the retailer, this also applies to non-physical items ordered. Information may also be sent back from the retail system to system 10 based on the sales volume for goods sold or merchandised through system 10, or alternatively the data can be sent via internet 70 to the corporate headquarters of the company providing, or operating, system 10. The communication interface is configured to supports any desired level of system control and communication. In one embodiment a front-end management subsystem is adapted for sending system information, such as usage, sales generated, and so forth automatically to a desired corporate entity. Examples of corporate entity include: system provider, retailer, company servicing the system, and so forth either separately or in any desired combination. This front-end management subsystem may generate information in the form of an instrument panel, reports, ticklers, status fields, and other convenient forms of display and/or interaction.

A network router 60 is shown driving the local loop, while an optional wireless router 62 can be used for communicating with wireless devices of system 10 or of the retailer. Intranet 58 is coupled to computer 64 of the retailer having data repository 66. The intranet is preferably shared with the point of sale systems 68a, 68b through 68n, although these may communicate by alternative means. Preferably, retail system 64 is adapted for communicating over internet 70, and sharing the connectivity with system 10.

The multimedia to be output by system 10 can be downloaded over Internet 70 through the retail system gateway to CPU 12 and storage subsystem 14. Storage subsystem 14 is preferably configured so that at least two full sets of multimedia presentations can be retained, coupled to a means of service party selection of which multimedia to display, wherein after physical content on the system is changed, the service person can then select the proper matching multimedia.

In one embodiment the system is configured for remotely-controlled management, monitoring, reporting, and upgrades. The connectivity is highly reliable and secure (firewall friendly) kiosk and network functionality. Self-diagnostic and self-correction capabilities are included within an embodiment to maintain a high up time rate. Complete administrative control of advertising and multimedia can be provided. This embodiment provides reliable and secure fully-hosted networking-management service. Service personnel can access the system through a local port for uploading or downloading as well as modifying operating parameters or for troubleshooting.

2.6 Identification Subsystem.

An identification means 72 is shown, such as having an ID subsystem 74 which can support any desired form of identification, such as a card reader 76 (which can also be configured for identifying specific carts), biometric circuit 78 with sensor(s) 80, or user entered identification 82, and so forth.

2.7 Servicing Ports.

A wired service port 84 is shown along with a wireless communication port 86 to allow authorized service personnel to change the offers presented by the system the operations thereof as well as to repair or upgrade system 10. In one mode the service person can carry an interface means 90, such as a portable terminal, or PDA. This may be wired or wireless (shown).

2.8 Bio Activity Sensing.

One optional feature of the system is a bio-sensing subsystem with electronics 92 coupled to a head unit 92. The bio sensing is used for detecting the level of pathogens on a surface, such as carts before and/or after sanitizing. The system can support a number of different forms of both pathogen detection and annunciation. In one embodiment, CPU 12 generates annunciations via audio device 34 or status outputs 32 based on high pathogen levels. In another embodiment a separate display 95 is provided for indicating levels of pathogens.

2.9 Position Sensing.

In one embodiment, a position sensing means is incorporated for detecting the position of the patrons, and/or their shopping carts. The ability to sense position allows the system to discern the intent of a patron to improve the operations of the system. For example it can be determined if the same patron is attempting to obtain an undue number of wipes from the system, or is attempting to tamper with the system and so forth. It can allow for automated dispensing, or for correlating the activating sensing wherein a wipe cannot be dispensed without the presence of a patron. These are but examples only, as position sensing can be utilized to support a number of features of the invention. A position sensing circuit 96 is shown with a sense head 98, although a plurality of sense heads may be utilized. Sensing may be performed utilizing ultrasonic sensing, optical sensing, pressure sensing, electric field sensing, inductance sensing, or any convenient method known in the art.

2.10 Distributed Interactive Subsystems.

In one embodiment interactive subsystems 100, located throughout the retail location are coupled to system 10, such as by direct communication or networking, either wired or wireless. Interactive subsystems may be housed in separate units on shelves, or in kiosks, or otherwise adapted to allow patron interaction. These subsystems are preferably located at departments within the retailer, such as meat section, drinks, produce, deli/food to go, breads-desserts, and so forth within a grocery store. Each interactive subsystem preferably containing a controller 102, display 104, audio generation 104, and input/output 106.

### 3.0 DIFFERENT EMBODIMENTS, ASPECTS, MODES, AND FEATURES

The present system is amenable to embodiment in a number of alternative ways and can provide numerous modes of operation, and numerous operating features. The following describes some of these embodiments, modes, and features which can be implemented separately or in combination thereof.

3.1 Automated Sanitized Wipe Dispensing.

In one embodiment sanitized wipes are dispensed automatically, the user need not extract them from a container. The system, in response to a user input, or sensing the presence of a user with cart, can dispense a wipe, or otherwise activate a cart sanitation process.

3.2 Non-Contact Wipe Dispensing.

An embodiment can be adapted with sensors for detecting a user request for a sanitizing wipe. For example, an optical sensor which registers input from the patron, such as the position of the hand of the user poised within a three dimensional “wipe request” area. The hardware, for example, can register the dispensing of sanitizing wipes in response to optical detection of user input. Detect a selection response from the hand of a user moved through a specific area; or alternatively a portion of the shopping cart or the like.

3.3 Multiple Wipe feeder.

In one embodiment, the system is adapted to dispense wipes to multiple queues of patrons. The system can be adapted to allow or prevent crossover (patrons receiving wipes for line B from Line A, or similarly for line A from Line B, or more preferably to allow crossover in response to a malfunction or supply outage in the other dispensers. By way of example, the selectivity of the dispenser selector is based in response to the location of the patron, when all dispensers are operating, or to a user input that is location specific (i.e., optical input). One implementation includes a detector for detecting when a problem arises with dispensing the sanitized wipes from a dual-substrate roll feeding through one container of sanitizing liquid.

3.4 Multiplicity Dispensing Limitation.

In one system embodiment, the system prevents a given user from taking an excessive number of sanitizing wipes. In one embodiment the system registers the movement of persons near the system and will not dispense more than a set number of wipes to a person that remains at the system requesting wipes, or that simply moves away and then returns. This movement can be detected optically, or by any convenient means. For example an optical beam is output (e.g., ultraviolet (UV), visible light, Infra-red (IR)), through a rotating optical head. An optical receiver picks up the output beam as reflected from objects in the circular path of the rotating optical head. The system can discern stationary and moving objects, while discernment of distance can be provided as well by modulating the optical beam and registering the path delay of the reflection. The software of the system is configured for detecting if the same party is attempting to retrieve multiple wipes. Additionally, or alternately, other forms of detection may be utilized, for example image capture systems which analyze motion and well as which can in one mode differentiate one party from another.

3.5 Selective Dispensing Characteristics.

In this embodiment, the system is configured to allow the user to select, such as via a non-contact input, a variation of the sanitizer to be used, such as the type of scent (e.g., no scent, selection of specific scent or combination) or other aspects. In one mode different sanitizing liquids are dispensed, or different liquids are added to the sanitizer, such as according to a selected fragrance. The user can thus sample different versions of the sanitizer. This is particularly appropriate when sanitizers are being offered for cooperative sale through merchandising system 36.

3.6 Trouble Reporting/Annunciation.

The system is configured to announce when supplies get low, or run out. By way of example and not limitation, the annunciation can comprise optical and/or audio indicators, and/or communicating over the retail system 11, or through internet 70 to personnel associated with servicing system 10.

3.7 Bacteria Resistant Carts Handles.

The cart handles are preferably manufactured from a bacteria resistant material to reduce the activity of pathogens and simplify the sanitizing operation. Optionally other portions of the cart subject to high probability of handling can be manufactured using anti-microbial materials or overlays, or be otherwise treated to reduce the hospitality of the surface to microbes. One such material contains nano-spikes on its surface, wherein the application of manual pressure impinges and ruptures membranes of bacteria, thus destroying them. Other such materials include “germ resistant” plastics.

3.8 Cart Condition Monitoring.

A means for displaying the condition of the cart is preferably implemented in relation to a germ “detector” built into the system, such as the kiosk. This means is configured to detect pathogens and generate an annunciation in response thereto. Coupling this device into the system, such as a stationary mounting, or less preferably able to be moved by the patron (e.g., attached to a translatable element of station (i.e., rotation, sliding, and so forth)) allowing user to check other parts of the cart). The annunciation preferably provides a simple to interpret output, such as Pass and Fail, or the like. The pathogen detection system is calibrated for use with these forms of pathogens on the given type of shopping cart, wherein a Pass/Fail, or a simple output scale can be used. The sanitary status may be indicated by the generation of sounds, voice output, tactile output and/or visual annunciations. In a preferred embodiment, a scale having a range from Pass (marked in green) to Fail (marked in red) is used with an uncertain center region of the scale marked in yellow.

3.9 Cart Filling Monitoring.

Items collected into the basket based on weight changes to the cart. If weight changes do not correspond with scanned items then checker is preferably alerted. If weight changes do not correspond with scanned items then user is alerted. Sufficient problems in this area can be cause for demoting user to lower “convenience” levels.

3.10 User Handle Promotion.

An anti-bacterial adhesive backed material is provided to the user for placing on the cart handle. These banner strips protect the patron while killing underlying germs. The material preferably contains printed advertising on exterior surfaces to defray at least a portion of the cost. These can be peeled off the store periodically as the layers build up, or less preferably by patrons as desired.

3.11 Multi-Use User Handle.

In this implementation, multi-use handles or handle covers are supplied to interested patrons, such as within a promotion. These can protect the patron from pathogens with each visit. Each handle/cover is preferably festooned with an advertising message.

3.12 Shopping Cart with Separable Sterilized Handle.

In this implementation, the shopping cart is configured with a readily removable handle. The handle is adapted to be readily sterilized, such as within a handle cleaning device, which may utilize heat liquids, steam, detergents, UV, IR, heat, and/or any other convenient method of sterilizing a surface. In one embodiment the act of inserting the cart into the rack causes automatic disengagement of the handle and receipt of the handle into a sanitizer means, wherein a plurality of handles are being disinfected. A user gets a freshly sanitized handle, couples it to the cart and is ready to shop.

3.13 Directed Sound with Position Keying.

Directed sound within a “key” area of the kiosk, which is particularly well suited for use with multiple screens providing simultaneous multimedia information. Each screen associated with a sub-key (i.e., also marked on floor). Party stands in a selected area to hear the audio for the item they are interested in learning about. Also can have the item list scroll from one screen to the next screen, for example with each screen displaying all items in sequence but shifted off by one item per screen, so that a “loop” is playing for each item constantly. In one mode an indicia is displayed in the corner of each screen which matches a set of markings on the floor to which the sound is directed. The items being represented, for example, may comprise a “Daily Dozen” of promotions.

3.14 Presentation Including Smells.

In one embodiment, the system is adapted with a repository of smells and a dispensing device which are actuated in response to consumer input, or automatically. By way of example, the smells are dispensed as a liquid which is atomized by the machine, such as using microdispensing nozzles. The machine also preferably includes means for localizing smells to the location of a specific patron.

3.15 Facial recognition.

Limiting the output of promotional consideration (e.g., coupons, discounts, samples, and so forth, or otherwise accrued) to customers in response to their presence at an associated presentation, or otherwise qualified by current or historical presence as determined in response to facial recognition. It should be appreciated that in a preferred embodiment the identification of the party is not determined, nor are photos retained.

The system preferably creates a set of data based on analyzing incoming image data. A photo can not be generated from the data there is no need for that level of detail, however, sufficiently resolution is provided to heuristically determine that an individual is unique.

3.16 Automated Product Survey Collection.

In one aspect of the invention information is collected as to user responses to the presentation for a given product. The collection of feedback can beneficially take any of a number of forms, or a combination thereof. Direct user feedback can be solicited, such as having them press a button to rate the product, asking them for verbal responses, or similar direct means. Alternatively, indirect means can be applied, such as the following. (1) Correlating the percentage of patrons which pick up coupons or additional information in response to watching a given presentation. (2) Determining the extent to which patrons select other offers to view (either by active input, or moving to view another presentation). (3) Registering non-verbal cues, such as the extent to which eye contact is maintained toward the multimedia presentation, the expressions registered on the face of the consumer, and other elements optically registered, or voiced comments registered by a microphone coupled to the system.

3.17 Automated Product Endorsement Collection.

In one mode of the system, information is collected from patrons that have used a given product toward informing other consumers. If the system is configured for recognizing a given consumer, such as through a club number or similar (i.e. based on RFID, or card swipe), then consumers which have previously purchased target product are asked for information about the product. Upon supplying feedback the system generates some form of credit or other inducement from the store or kiosk to the patron which has a value during that visit and/or at a later time. The inducement is preferably provided based on a response being given—not only for favorable responses. The endorsement may be simple, such as in the form of a good/bad selection, input by keys, non-contact sensors, verbal recognition and so forth. Endorsements may also comprise more complex input, such as audio and/or video logging of the endorsement. A form of multimedia blog can be kept as well with information from the consumer. Specific types of information may be requested of the user. For example did the product operate as advertised? Were there any problems with understanding the direction? To whom would they recommend the product? It will be appreciated that marketing information needs can vary on a product-by-product basis. This additional information can provide a window of understanding to the developers of a new product. In one mode of operation, select endorsements can be output by the system, or in response to user selection of more detailed modes of presentation. The system preferably includes a means for accepting a release from the patron, in particular if audio or video are to be captured for use in the system. One example is the use of a touch screen, in air placement detection, proximity detection, and so forth. In another example verbal cues are collected from the patron along with the product use information.

3.18 Incentivized Electronic Shopping Cart.

In this aspect of the invention, the shopping cart is configured with electronics or carts having an identifier read by a central system. In one embodiment the electronics can receive a wireless communication of a coupon, certificate, bonus, or other incentive for use when the user reaches the register, or in certain stores during the process of a patron checking out their own items through the scanner. Alternatively, the code from the cart (e.g., bar code registered from the cart, or RFID or obtained by similar identification means for the cart), is communicated from the kiosk to a central computer which is referenced at checkout so that the digital coupons can be redeemed. Optionally, a display on the cart can be used to display the digitally received incentives, as well as other functions such as logging in of the items picked up during shopping. These can be scanned by the system at the time of being collected from the shelf. The system can be setup to allow the user to gain additional information about the items when they are scanned and put into the cart. This also simplifies checkout in that the user need not take items out of the cart to perform rescanning.

3.19 Crowd Responsive Presentations.

In one embodiment of the invention, the system is configured to register the number or density of patrons at the multimedia presentation system. In response to the level of crowding in the present area, the system is configured to change the length and nature of the presentations, or may drop into a non-interactive mode to speed patrons through that portion of the store to assure that crowding does not accumulate.

3.20 Store Maintained “Convenience Levels”.

In one implementation the system supports an honor system which is enforced to provide enhanced “convenience levels” to those deserving of them. Honor system enforcement. Most patrons are honest, but it is the few who will try and take advantage of every labor and cost saving program of the store. Therefore, this implementation of the system is configured to require qualification of the patrons for using the more advanced systems, such as automatic checkout, in which the cart can pass through checkout without the need to remove items. The patron can take bags on the way in and place these items in the bags after they are scanned. In this way the amount of handling and time is minimized. This works well with the aspect of the checkout scanner disclosed by one of the inventors in a prior patent, in which video segments are collected at the checkout point, optionally with additional information as well (e.g., weight, ultrasonic signature, RFID information collected, videos collected in the store and so forth). In this way those only those persons that can be trusted can use certain advanced features of the system.

3.21 DeTagging Station.

In this embodiment, a DeTagging station is incorporated, such as within a kiosk that is visited by patrons when leaving, or about to leave the retail establishment. Some consumers are concerned about “big brother” using RFID tags to collect information on their use of products in the home. Tags according to the this aspect of the invention are thus configured to allow their removal and/or destruction from articles after purchase. The kiosk is configured with hardware and/or electronics to allow the patron to remove the tag and/or destroy the tag, such as with a punch or more preferably a high voltage electrostatic pulse (like electrostatic discharge (ESD)—such as when walking across carpet and touching door handle). Electronics is very sensitive to ESD which ruins the circuits from a combination of either fusing, or anti-fusing (creating an open circuit) of the electrical components. The removal/destruction aspect is coupled to an RFID test device, which can detect the presence singly, or more preferably in combination, of RFID tags which have not yet been disabled. In one embodiment of the invention a portion of the kiosk is set aside with shielding to prevent interference with other stations (and of course to prevent “big brother” from further invading their privacy in determining which tags are removed. The station can be configured with a disposal site for the tags, wherein they are properly recycled or disposed of. Furthermore, the tags can be read prior to destruction, therein allowing the retailer to determine to which products the patrons are most sensitive to the use of RFID tags.

3.22 Augmented Virtual In-Store Catalog Shopping.

Many patrons are still concerned with sharing financial information over the internet and thus are not willing to shop over the internet. Therefore, according to one aspect of the invention an interactive display is provided for shopping for select items on-line from inside the store. The selection of external retailers is determined by the store and the patron can shop for items not available at the store. The financial transaction, however, is performed at the register at the time of purchase, although the billing to a credit account may not arise until the items is actually shipped or service performed. The store receives a percentage of the sale for handling the transaction, and the shopper gains additional convenience and security. The “off-retail shopping” according to this aspect of the invention can be performed using a general purpose catalog kiosk or similar, in which the user selects a product category and proceeds to define their needs.

Alternatively, and more preferably, a display system with user input devices (preferably non-contact) are distributed at different centers about the store, wherein items associated with that part of the store are highlighted for “off-retail” shopping. For example a user in the meat section, unable to find indigenous farm-raised quail, can choose to find it using the system which is already in a mode for searching for meat related products. All of the items selected during a shopping trip for off-line purchase are consolidated—for instance DVDs and lawn furniture may be received from the same internet retailer, wherein the order is not actually actuated until the patron executes the transaction at the register.

The system can be adapted to show only items from the off-store source which are not carried by the store, or which are out of stock by the store. It is preferred that the retailer operate as a middle-man in the financial transaction, wherein the financial information of the patron need not be shared with the off-retail establishment. In addition, the packages can even be delivered to the retailer for pickup by the patron, such as upon entering their order information or their identity being registered by the system on a subsequent visit. This aspect increases the convenience to the patron—increasing the ability for one-stop shopping, while increasing the revenues for the retail establishment.

### 4.0 METHOD DESCRIPTION OF MARKETING SYSTEM

FIG. 2 represents an embodiment 150 of the general flow for a method of retail marketing which operates in response to a cart sanitizing inducement. After start at block 152, a cart sanitizing means is established at block 154 in a retail establishment by a system operator. A secondary marketing center is established in the retail establishment as per block 156, which may be co-located with the cart sanitizing system, or physically displaced therefrom. Sales of items from the secondary marketing center are registered as per block 158 at the retail establishment. The sale may be either the sale of a physical item or an order placed in response to the operation of the secondary marketing center. A consideration is remitted, such as a financial consideration, from the retail establishment to the system operator as per block 160. It will be appreciated that numerous variations of this method can be implemented with one of ordinary skill in the art without departing from the teachings herein.

### 5. CONCLUSION

Accordingly, it will be seen that this invention provides services to patrons of various retail shopping venues, a merchandising mechanism for retailers, a sanitization control system, and numerous beneficial aspects. It will be appreciated that the invention can be implemented in a variety of ways, for which only examples have been provided. It will be further appreciated that one of ordinary skill in the art can modify these teachings without departing from the present invention. Preferred elements of the invention may be referred to whose inclusion is generally optional, limited to specific applications or embodiments, or with respect to desired uses, results, cost factors and so forth which would be known to one practicing said invention or variations thereof.

Moreover, a retail merchandising method and system according to the various embodiments of the invention may be provided with all of the features described herein, or only portions thereof, which combinations may be practiced and/or sold together or separately.

It should be appreciated that each aspect of the invention may generally be practiced independently, or in combinations with elements described herein or elsewhere depending on the application and desired use. Modes may be utilized with the aspects described or similar aspects of this or other devices and/or methods. Embodiments exemplify the modes and aspects of the invention and may include any number of variations and features which may be practiced with the embodiment, separately or in various combinations with other embodiments.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

We claim:

1. An apparatus for retail marketing in response to a cart sanitizing inducement, comprising:
means for sanitizing a shopping cart in preparation for patron use at a retail establishment;
wherein said sanitizing means is provided by a system operator;
means for displaying a select group of items for sale at the retail establishment;
wherein a display area for said select group of items is provided by the retail establishment in a full or partial exchange with said first system operator for providing the means for sanitizing said shopping cart; and
means for remitting at least a portion of the sales of said select group of items in said retail establishment, to said first system operator.

2. An apparatus as recited in claim 1, wherein said means for displaying the select group of items is configured for either physically displaying items for purchase, or presenting coupons, or presenting information about items available for purchase either in the retail establishment or from third parties.

3. An apparatus as recited in claim 2, wherein said means for displaying the select group of items comprises a display apparatus configured for retaining a plurality of said group of items which may be physically removed from said means for displaying for purchase by the patron.

4. An apparatus as recited in claim 2, wherein said means for displaying the select group comprises a video or multimedia presentation system upon which information is provided on said select group of items.

5. An apparatus as recited in claim 1, wherein said first system operator maintains said means for displaying with said select group of items.

6. An apparatus as recited in claim 1, wherein said means for remitting a portion of sales comprises:
a retail trade computer system configured for executing purchase transactions in response to item codes, or UPC codes; and
programming operable on said retail trade computer for,
(i) tracking purchases of goods within said select group of items,
(ii) determining a remittance on the purchase of each item sold from said select group,
(iii) summing the total remittances over an interval of time,
(iv) executing a payment of said total remittances to said first system operator, or communicating said total remittances within the retail establishment toward a payment being generated to said first system operator.

7. An apparatus as recited in claim 1, wherein said sanitizing means comprises a sanitizing station configured for dispensing a sanitizing agent, or sanitizing wipe.

8. An apparatus as recited in claim 7, wherein said sanitizing station is configured for dispensing a wipe having sufficient disinfectant to substantially reduce the biological hazard posed by an unsanitized cart handle, or portion of the cart.

9. An apparatus as recited in claim 1, wherein said first system operator is a separate entity from said retail establishment.

10. An apparatus as recited in claim 1, wherein said first system operator is a separate profit-loss center for said retail establishment.

11. An apparatus as recited in claim 1, wherein said sanitizing means comprises a sanitizing station configured for continuous sanitizing of carts using mechanisms selected from the group of sanitizing elements consisting essentially of chemical, detergents, electromagnetic radiation, ultraviolet, infrared, heat, ultrasonic, and acoustic.

12. An apparatus as recited in claim 1, wherein said retail establishment is selected from the group of retail trades consisting essentially of: grocery stores, drug stores, super stores, boutiques, mall stores, hardware stores, stationary stores, closeout stores, chain stores and independent retail stores.

13. An apparatus as recited in claim 1, further comprising means for displaying pre-paid advertising alone by product marketers (vendors) based on products in retailer stock-on-hand or standard repetitive stock.

14. An apparatus as recited in claim 1, further comprising means for recording and/or analyzing all kiosk-based or register-based transactions tied to kiosk-based product promotion at said retail establishment.

15. An apparatus for retail marketing in response to a cart sanitizing inducement, comprising:
means for sanitizing a shopping cart in preparation for patron use at a retail establishment;
wherein said sanitizing means is provided by a first system operator;
a video or multimedia presentation system upon which information is provided on a select group of items for sale at the retail establishment;
wherein a display area for said select group of items is provided by the retail establishment in exchange with said first system operator for providing the means for sanitizing said shopping cart; and
a retail trade computer system configured for executing purchase transactions in response to identification of said select group of items in said retail establishment; and
programming operable on said retail trade computer for,
(i) tracking purchases of goods within said select group of items,
(ii) determining a remittance based on the purchase of each item sold from said select group,
(iii) summing the total remittances over an interval of time,
(iv) executing a payment of said total remittances to said first system operator, or communicating said total remittances within the retail establishment toward a payment being generated to said first system operator.

16. An apparatus as recited in claim 15, wherein said sanitizing means comprises a sanitizing station configured for dispensing a sanitizing agent.

17. An apparatus as recited in claim 15, wherein said first system operator maintains said means for sanitizing and said cart disinfecting means.

18. A method of extending retail marketing through a cart sanitizing inducement, comprising:
establishing a cart disinfecting means at a first retailer by a first system operator;
establishing a secondary marketing center by said first system operator at said retail establishment, said retail establishment maintaining a primary marketing environment;
wherein physical space for said secondary marketing center is provided by said retail establishment in exchange for the operation of said cart disinfecting means;
offering at least one item for sale at said secondary marketing center for purchase by patrons of said retail establishment; and
remitting a portion of the sale of said at least one item by said retail establishment to said first system operator.

19. A method as recited in claim 18, wherein said secondary marketing center includes at least one video or multimedia presentation system to present products and services being marketed at said secondary marketing center.

20. A method as recited in claim 18, wherein said first system operator maintains said secondary marketing center and said cart disinfecting means.
